(19) United States
(12) Patent Application Publication
(10) Pub. No.: US 2024/0102665 A1
(43) Pub. Date: Mar. 28, 2024

(54) STOVE STRUCTURE WITH LIFT-OFF LID

(71) Applicants: Yu Lu, New Taipei (TW); Thirtieth Sense Co., Ltd., New Taipei (TW)

(72) Inventor: Yu Lu, New Taipei (TW)

(21) Appl. No.: 17/950,111

(22) Filed: Sep. 22, 2022

(51) Int. Cl. F24C 15/12

(52) U.S. Cl. CPC F24C 15/12

(57) ABSTRACT

The present disclosure relates to a stove structure with lift-off lid, including at least a stove body and a lid. The two opposite sides of the inner wall of the stove body are equipped with a fixed base and an elastic pin, wherein the front end of the elastic pin has a sloping surface and its rear end can be pulled for control. The lid has a hinge plate and a buckle head corresponding to the fixed base and the elastic pin respectively. When the hinge plate is embedded and the lid is covered to the stove body, the buckle head will push the sloping surface of the elastic pin to move backward, and after the buckle head traverses the sloping surface, the elastic pin will be reinstated to buckle against the buckle head, so that the lid can be quickly combined and fixed with the stove body.

### FIELD OF THE INVENTION

The present disclosure is a stove structure with lift-off lid, particularly a stove structure that can be fixed by the user with one hand and is easy to lift and carry.

### BACKGROUND OF THE INVENTION

In a variety of favorite outdoor activities, events of camping, picnics, or barbecues are widely held among the public, and in order to prevent damage to the outdoor environment, a stove is usually used as a fire source, and for the convenience of users to carry, there a stove structure has been designed by the industry, a stove base 101 at the two opposite sides of the inner wall have a base 11 and a pin 12, and a stove lid 102 has a hinge plate 13 and a socket 14 corresponding to the base 11 and the pin 12. Wherein the front and rear ends of the pin 12 are placed through the inner and outer sides of the stove wall (as shown in FIG. 1), the base 11 is provided for embedding by the hinge plate 13, and the front end of the pin 12 can be inserted into the socket 14, as for the rear end of the pin 12 is a pulling end for the user to pull and control the pin 12 to insert or withdraw from the socket 14 of the stove lid 102. When operating, the user holds the stove lid 102 to embed the hinge plate 13 into the base 11 of the stove base 101, and then pulls the pin 12 with the other hand and inserts it into the socket 14 of the stove lid 102 (as shown in FIGS. 2 to 5), so that the stove base 101 and the stove lid 102 can be fixed to each other for carrying.

However, in actual use, regardless of what activities are being carried out, the hands of the participants may hold meals or utensils, if they want to hold the stove, have to put aside the items in hand before they can use both hands to fix the stove base 101 and stove lid 102 to each other then carry, it's quite inconvenient.

Therefore, how to improve the above deficiencies, providing a convenient stove structure for combination, and fixing the stove lid and stove base is the technical challenge that the inventor of the present disclosure is anxious to think about and improve.

### SUMMARY OF THE INVENTION

The purpose of the present disclosure is to provide a stove structure with lift-off lid which is composed of at least a stove body and a lid; the two opposite sides of the inner wall of the stove body are equipped with a fixed base and an elastic pin, wherein the elastic pin place through the wall of the stove, the front end of the elastic pin has a sloping surface and its rear end can be pulled for control. The lid has a hinge plate and a buckle head corresponding to the fixed base and the elastic pin of the stove body respectively, and the hinge plate is able to embed in the fixed base. When the hinge plate is embedded and the lid is covered to the stove body, the buckle head will push the sloping surface of the elastic pin to move backward, and after the buckle head traverses the sloping surface, the elastic pin will be reinstated to buckle against the buckle head, so that the lid can be quickly combined and fixed with the stove body, so as to provide a stove structure that can be operated with one hand and is easy to fix and carry.

To achieve the above purpose, there is a limiter provided at the left and right ends of the fixed base respectively, so that the hinge plate of the lid can be precisely embedded in the fixed base, on the other hand, the elastic pin is equipped with at least one elastic element inside, so that the elastic pin can be quickly reinstated after movement, so as to achieve the purpose of fixing stove body and the lid with each other easily.

### BRIEF DESCRIPTION OF THE DRAWINGS

FIG. 1 is a schematic diagram of a three-dimensional structure of a conventional stove;

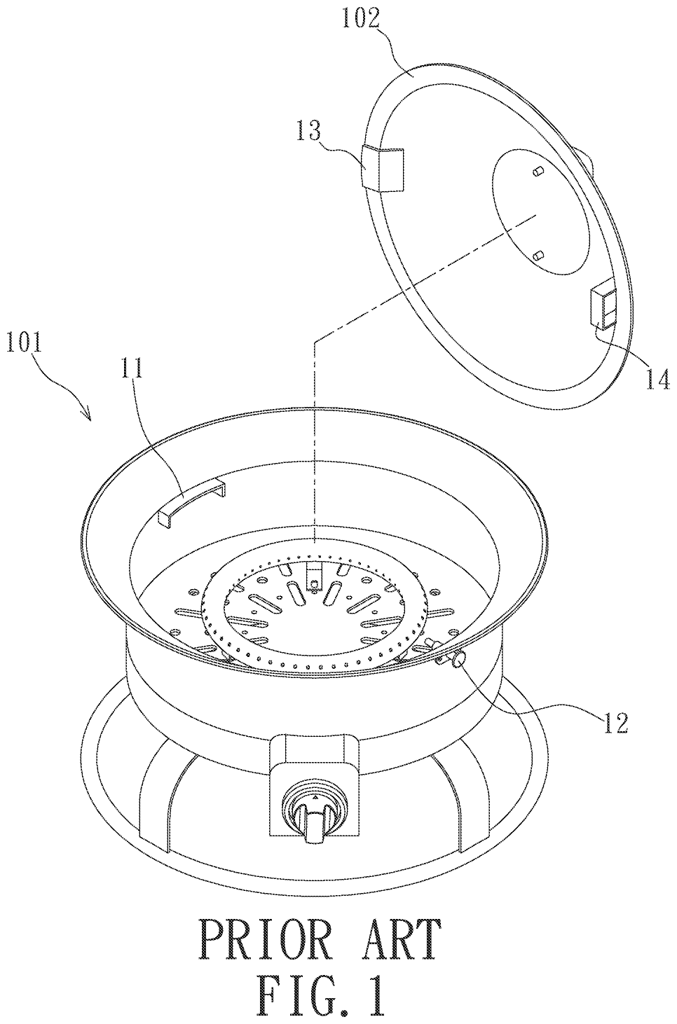

FIG. 2 is the first schematic diagram of the cross-sectional structure of the conventional stove, showing the state in which the stove lid is to be covered on the stove base;

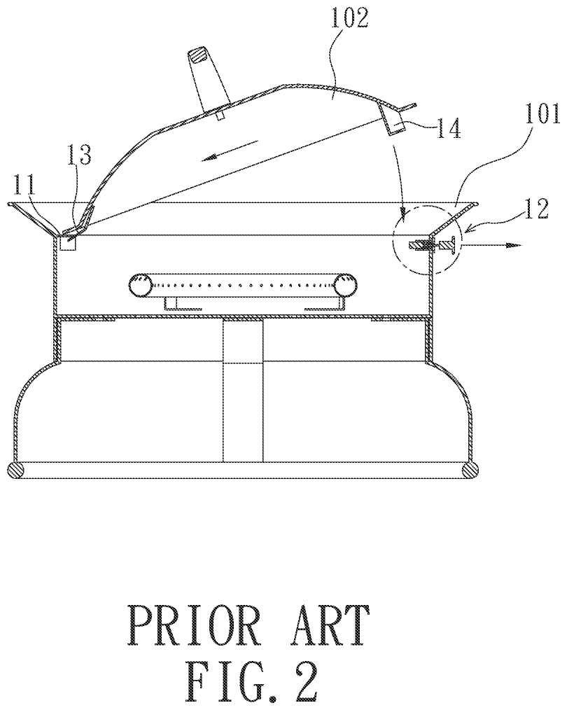

FIG. 3 is a partially enlarged schematic diagram of FIG. 2;

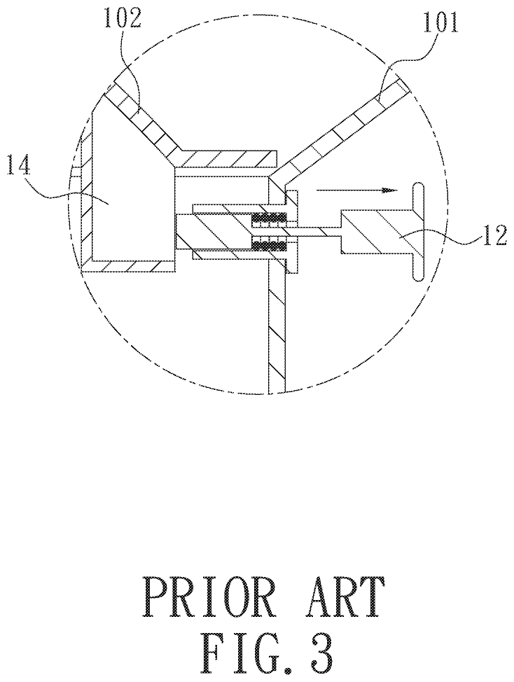

FIG. 4 is the second schematic diagram of the cross-sectional structure of a conventional stove, showing the state in which the stove lid and the stove base are fixed to each other;

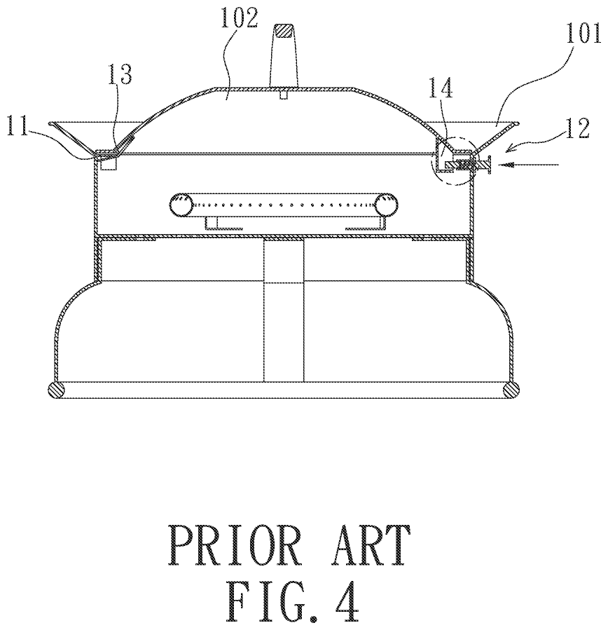

FIG. 5 is a partially enlarged schematic diagram of FIG. 4;

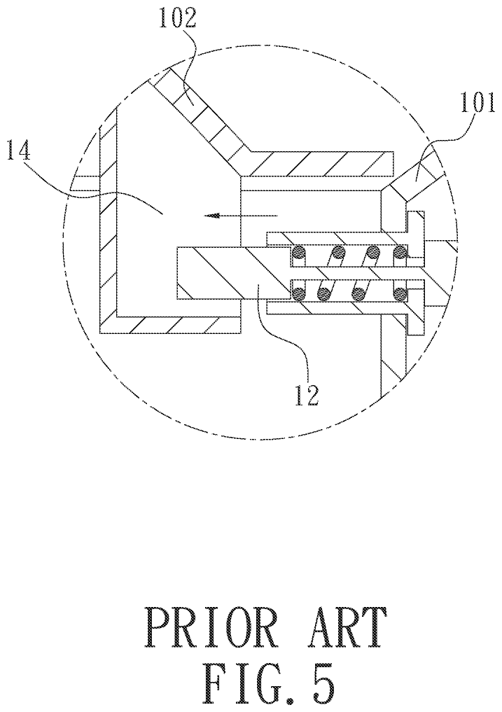

FIG. 6 is a schematic diagram of the three-dimensional structure of the present disclosure;

FIG. 7 is the first schematic diagram of the cross-sectional structure of the present disclosure, showing a state in which the lid is to be covered on the stove body;

FIG. 8 is a partially enlarged schematic diagram of FIG. 7;

FIG. 9 is the second schematic diagram of the cross-sectional structure of the present disclosure, showing the state in which the lid and the stove body are fixed to each other; and

FIG. 10 is a partially enlarged schematic diagram of FIG. 9.

### DESCRIPTION OF THE PREFERRED EMBODIMENTS

In order to achieve the above purpose and efficacy, the technical means and structures used in the present disclosure are illustrated below with respect to the preferred embodiments and will describe the features and functions of which in detail for better understanding.

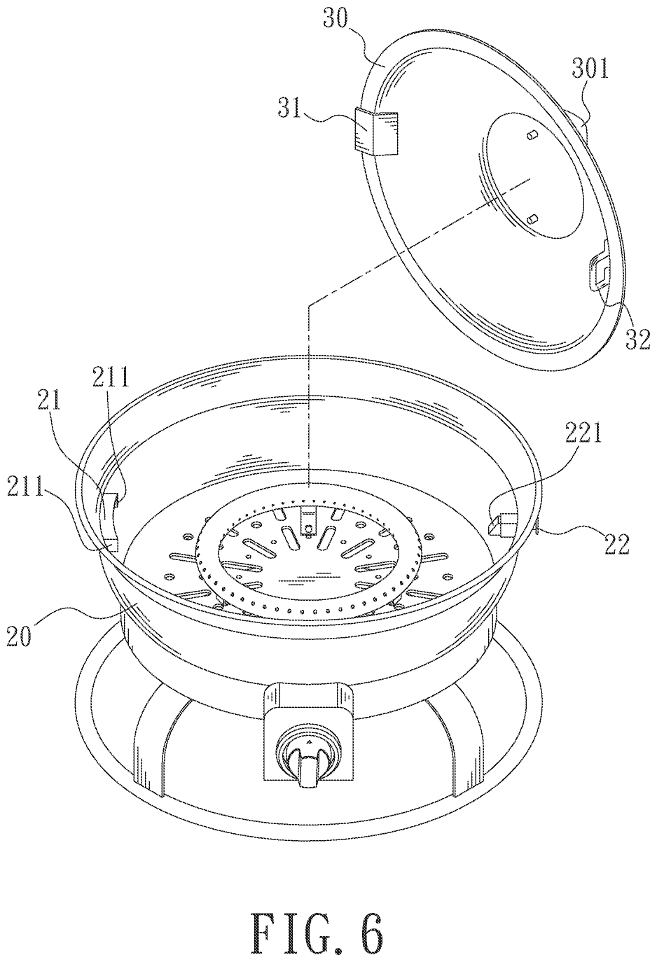

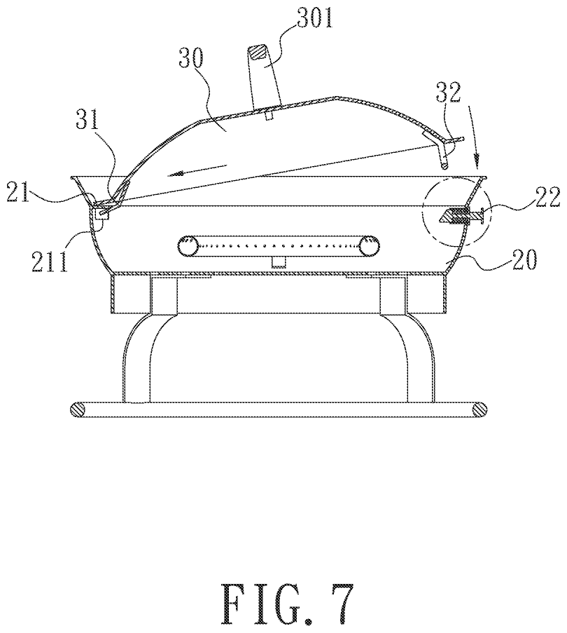

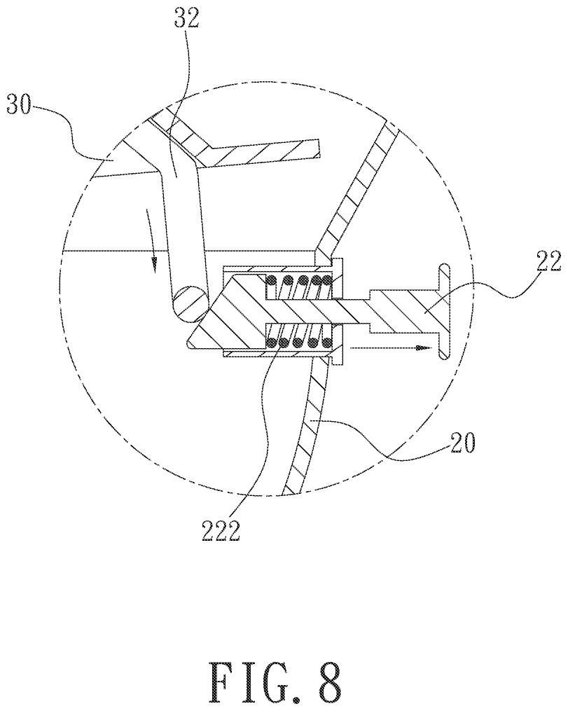

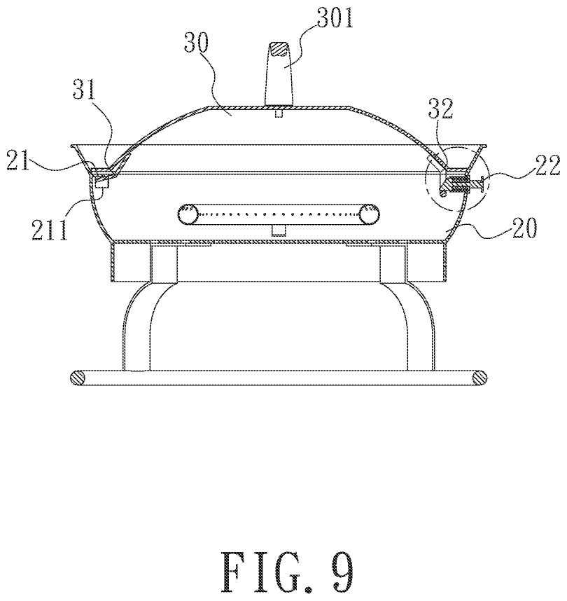

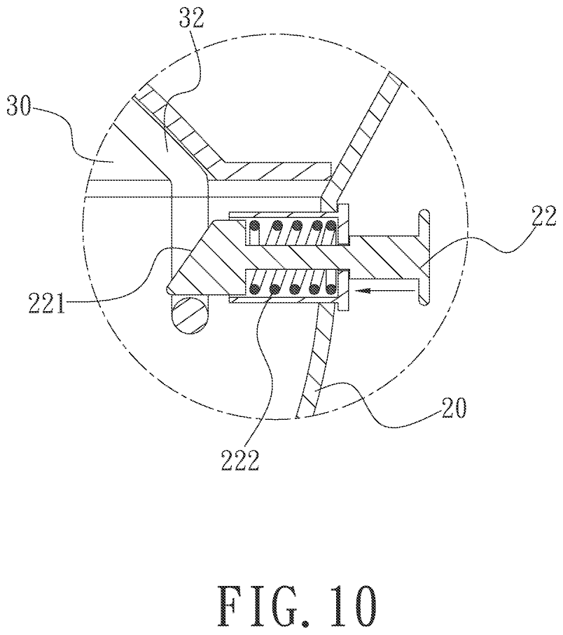

Referring to FIGS. 6 to 10 which are a schematic diagram of the three-dimensional structure, a schematic diagram of the cross-sectional structure, and a partially enlarged schematic diagram of the cross-sectional structure of a preferred embodiment of the present disclosure, as shown in these drawings, a stove structure with lift-off lid that is easy for fixing and carrying, comprising at least:

A stove body 20, having at least one fixed base 21 and at least one elastic pin 22 on two opposite sides of the inner side of the stove wall, the front and rear ends of the elastic pin 22 are respectively placed through the inner and outer sides of the stove wall, and the front end of the elastic pin 22 has a sloping surface 221 and its rear end can be pulled for control; and

A lid 30, having at least one handle 301, and having at least one hinge plate 31 and one buckle head 32, the hinge plate 31 is able to be embedded in the corresponding fixed base 21 of the stove body 20, and the buckle head 32 is able to be buckled by the corresponding elastic pin 22 of the stove body 20, so that the lid 30 and the stove body 20 can be combined and fixed with each other.

Wherein, the left and right ends of the fixed base 21 are each provided with a limiter 211;

Wherein, the elastic pin 22 has at least one elastic element 222 inside; and

Wherein, the buckle head 32 is a rod with a U-shape or O-shape.

The purpose of the present disclosure is to provide users with easy fixation and lifting, so that when users hold the lid 30, they can combine the lid 30 with the stove body 20 to fix each other directly, and users can hold the lid 30 by the handle 301 with one hand, and when hinge plate 31 of the lid 30 is embedded in the corresponding fixed base 21 of the stove body 20, and the lid 30 is covered to the stove body 20, the buckle head 32 will push the corresponding sloping surface 221 of the elastic pin 22 to slide backward, and after the buckle head 32 traverses the sloping surface 221, the elastic pin 22 stops sliding and resiliently reinstates to buckle against the buckle head 32, so that the user can combine the lid 30 with the stove body 20 to fix each other with one hand, to achieve the purpose of easy fixing and carrying.

Under the above, there is the limiter 211 provided at the left and right ends of the fixed base 21 of the stove body 20 respectively, the limiter 211 is to limit the hinge plate 31 embedded in the fixed base 21 in a relevant position, and to assist the buckle head 32 of the lid 30 that can be directed to the corresponding elastic pin 22 of the stove body 20 when the lid body 30 is covered to the stove body 20, so that the buckle head 32 is able to push the sloping surface 211 of the elastic pin 22 directly, and buckle against the buckle head 32 by the elastic pin 22 after the buckle head 32 traverses the sloping surface 221, to achieve the purpose of the lid 30 and the stove body 20 that are easily combined and fixed with each other.

In addition, as shown in FIG. 6, the buckle head 32 of the lid 30 is a rod with a U-shape design, but it may also be an O-shaped rod or other structure that can serve the same function, but should be able to be buckled by the elastic pin 22 after pushing and traversing the sloping surface 221 of the elastic pin 22, as described herein.

In summary, compared with the conventional stove with deficiencies and problems that cannot be solved, the present disclosure through the special design of the fixed base 21, elastic pin 22, hinge plate 31, and buckle head 32, not only the lid 30 can be combined and fixed with the stove body 20, but also through the sloping surface 221 of the elastic pin 22, the user can hold the lid 30 with one hand to combine and fix the lid 30 with the stove body 20 efficiently, to achieve the effectiveness of easy fixing and carrying.

The above-described embodiments are intended to illustrate one of the preferred embodiments of the present disclosure and are not intended to limit the scope of the present disclosure. Any person skilled in this art may, without departing from the spirit and scope of the present disclosure, make certain variations and embellishments, and therefore the scope of protection of the present disclosure shall be subject to the scope of the claims attached hereto.

What is claimed is:

1. A stove structure with lift-off lid, comprising at least:
a stove body, having at least one fixed base and at least one elastic pin on two opposite sides of an inner side of the stove wall, a front end and a rear end of the elastic pin being placed through the inner side and an outer side of the stove wall respectively, and the front end of the elastic pin having a sloping surface, and the rear end of the elastic pin being pulled for control; and
a lid, having at least one handle, at least one hinge plate, and at least one buckle head, the hinge plate is embedded in the corresponding fixed base of the stove body, and the buckle head is buckled by the corresponding elastic pin of the stove body, so that the lid and the stove body can be combined and fixed with each other.

2. The stove structure with lift-off lid according to claim 1, wherein a left end and a right end of the fixed base are each provided with a limiter.

3. The stove structure with lift-off lid according to claim 1, wherein the elastic pin has at least one elastic element inside.

4. The stove structure with lift-off lid according to claim 1, wherein the buckle head is a rod with a U-shape or O-shape.
